(19) United States
(12) Patent Application Publication
(10) Pub. No.: US 2024/0212872 A1
(43) Pub. Date: Jun. 27, 2024

(54) LIQUID METAL OR MOLTEN SALT(S) REACTOR INCORPORATING A DECAY HEAT REMOVAL (DHR) SYSTEM THAT REMOVES HEAT THROUGH THE PRIMARY REACTOR VESSEL, COMPRISING A MODULE OF PASSIVELY OR ACTIVELY TRIGGERED PIVOTING FINS LOCATED IN THE GUARD GAP

(71) Applicant: COMMISSARIAT A L'ENERGIE ATOMIQUE ET AUX ENERGIES ALTERNATIVES, Paris (FR)

(72) Inventors: Alessandro PANTANO, SAINT PAUL LEZ DURANCE (FR); Philippe AMPHOUX, SAINT PAUL LEZ DURANCE (FR)

(73) Assignee: COMMISSARIAT A L'ENERGIE ATOMIQUE ET AUX ENERGIES ALTERNATIVES, Paris (FR)

(21) Appl. No.: 18/538,496

(22) Filed: Dec. 13, 2023

(30) Foreign Application Priority Data
Dec. 15, 2022 (FR) 22 13408

(51) Int. Cl. G21C 15/18; G21C 1/03; G21C 15/28

(52) U.S. Cl. CPC G21C 15/185; G21C 1/03; G21C 15/28

(57) ABSTRACT

A nuclear reactor incorporating a DHR system that simultaneously guarantees removal of decay heat as soon as the reactor is shut down; removal of heat through the primary vessel and then behind the secondary vessel; improved and entirely passive (Seebeck effect) heat removal by thermal conduction through fins distributed around the primary vessel in the guard gap and which, when pivoted into their deployed position, form a kind of thermal bridge between the primary and secondary vessels.

### TECHNICAL FIELD

The present invention relates to the field of fast neutron reactors cooled by liquid metal, notably by liquid sodium, and referred to as SFRs (Sodium Fast Reactors) which are part of the generation-IV family of nuclear reactors.

More particularly, the invention relates to an improvement to the function whereby decay heat is removed from these nuclear reactors.

The invention applies equally well to small or medium reactors of the SMR (Small Modular Reactor) type, typically having an operating power of between 50 and 200 MWe, or to high-power reactors typically having an operating power in excess of 200 MWe.

It will be recalled here that the decay heat (or residual heat) of a nuclear reactor is the heat produced by the core after the nuclear chain reaction has been shut down and which consists mainly of the energy of the decay of the fission products.

Although the invention is described with reference to a sodium fast reactor, it applies to any other metal such as lead used as a coolant in a nuclear reactor primary coolant circuit. It also applies to molten salt(s) reactors.

The invention is described with reference to a liquid metal reactor of the type having an integrated pool-type primary coolant circuit, which is to say one where the entirety of the primary coolant sodium is contained within the main vessel (primary vessel) in which the primary coolant pumps and the intermediate heat exchangers (IHX) are immersed through the reactor vessel closure.

It also applies to a reactor having a loop-type primary coolant circuit, which is to say one where the primary coolant pumps and the intermediate heat exchangers are placed outside the primary reactor vessel, which then contains nothing more than the core, these cooling components being connected to the core by the primary coolant piping.

### PRIOR ART

In nuclear reactors, the fundamental safety functions which need to be assured under all circumstances (normal operation, incident and accident) are containment, control of reactivity, and the removal of heat from the core.

As regards the removal of decay heat in an accident situation, there is an ongoing search to improve the passivity and to diversify the systems in order to guarantee better overall reliability. The objective is to preserve the integrity of the structures and of the geometry thereof under all circumstances, namely that of the first (fuel assembly pin cladding) and second (main vessel) containment barriers, and to do so even in the event of a long-term station blackout, which corresponds to a scenario of the Fukushima type.

More particularly, it is now envisaged for the removal of decay heat from a liquid metal reactor to be performed entirely passively through the main vessel. While this objective appears to be not entirely achievable in the case of a large-sized reactor, because of the excessively high power, it may be considered to be realistic for low-powered SMRs, so as to guarantee an intrinsic improvement to safety and decay heat removal systems, hereinafter referred to as DHR systems or DHRS, that remove heat through the main vessel.

In general, DHRSs that are in production or known from the literature for pool-type sodium reactors can be classified into a number of categories:
those employing a sodium/sodium (or sodium/NaK) heat exchanger placed within the cold header of the reactor, referred to as type RRA reactors (reactors with type-A reactor cooling) in publication [1]. Reference may be made to the acronym DRACS (which stands for “Direct Reactor Auxiliary Cooling System”) in FIG. 2 of this publication [1];
those employing a sodium/sodium (or sodium/NaK) heat exchanger placed within the hot header of the reactor, referred to as type RRB reactors (reactors with type-B reactor cooling) in publication [1]. Reference may be made to the acronym DRACS in FIG. 2 of this publication [1];
those employing a sodium/sodium (or sodium/NaK) heat exchanger placed within the secondary loops, with the acronym IRACS (“Intermediate Reactor Auxiliary Cooling System”) in publication [1]. Reference may be made to the acronym BPR in FIG. 2 of this publication [1]. In order to allow these BPR systems to operate, a fraction of the flow of secondary sodium is tapped off by the secondary loops to exchange heat with the intermediate sodium of the DHR circuit.
those employing cooling via the steam generator (SG), either using a stream of air that cools the external walls or using the water of the emergency back-up cooling system. Reference may be made respectively to the acronyms SGACS (“Steam Generator Outer Shell Decay Heat Removal”) and ASG (emergency feedwater) in FIG. 2 of publication [1];
those employing means for removing heat by radiation from the primary (main) reactor vessel in the event of an accident, and referred to as type RRC reactors (reactors with type-C reactor cooling through the main vessel) in publication [1]. Reference may be made to the acronym RVACS (which stands for “Reactor Vessel Auxiliary Cooling System”) in FIG. 2 of this publication [1];
those employing cooling by natural convection of air cooling the external surface of the secondary reactor vessel. Reference may be made to FIG. 15 of publication [2].

All of the abovementioned systems transfer the removed heat to a coolant fluid of the sodium or NaK or coolant oil type which exchanges heat with a cold source that is either air or water. The DRACS systems of type RRA and RRB have the major disadvantage of taking up space inside the nuclear boiler, requiring a primary vessel of greater diameter. This aspect may prove restrictive in terms of the transportability of the primary vessel by road or by river in the case of a reactor design of the small modular reactor (SMR) type.

IRACS and SG-based cooling systems often require intervention on the part of an operator or an electrical power supply. In addition, the fact of extracting the heat further away from the nuclear boiler is no longer assured, in the event of a malfunction, such as a sodium leak in the secondary coolant circuit in the event of an accident of the SBO (“Station BlackOut”).

Systems that cool the secondary vessel by natural air convection are limited to smaller-power reactors. In addition, in order to have a natural air circulation flow rate that is sufficient to cool the external surface of the secondary vessel, a sizeable air draft needs to be provided. In order to achieve this, the nuclear boiler needs to be of significant height, and this too imposes construction constraints regarding the depth of the reactor pit and the associated civil engineering works.

Systems of the RVACS type have the main advantage both of being in close proximity to the nuclear boiler and of not taking up space inside the primary vessel. Thus, these DHR systems of RRC type encourage a more compact configuration of nuclear boiler as well as significant diversification in comparison with the other aforementioned systems.

In spite of these advantages, DHR systems of RRC type do not offer good cooling performance because cooling is achieved by radiation from the secondary vessel. Specifically, the components of the systems (heat exchangers, pipe bundles or air flow) are mostly on the outside of the secondary vessel, facing the external surface thereof, and this limits the performance because of the thermal resistance of the gas present in the gap between the vessels (hereinafter referred to as the guard gap), which is to say the space between the primary vessel and the secondary vessel (the guard vessel).

The volume of the guard gap ensures accessibility to the devices that periodically inspect the condition of the external face of the primary (main) vessel. For safety reasons, this space is filled with an inerting gas, i.e. a gas free of water vapour, so as to eliminate the possibility of reaction with the sodium in the event of a leak from the main vessel.

The inerting gas, typically nitrogen, present in the guard gap has a very low coefficient of convection, typically comprised between 100 and 500 W/m²·K, which constitutes a factor that limits:
heat loss through the main reactor vessel during normal operation. By acting as an insulator, this gas thus contributes to the overall energy efficiency of the reactor in that it allows a greater amount of heat to be profitably utilized via the energy conversion system,
the rise in temperature in the secondary vessel, in an accident situation, thereby considerably limiting the decay heat removal flow.

Systems other than RVACS systems have been considered for RRC-type reactors in order to reduce the thermal resistance of the guard gap as far as possible and thus increase the temperature of the secondary vessel. Specifically, increasing the temperature of the secondary vessel would in fact lead to an increase in the thermal power PDH_{R} of the heat that can be removed in the event of an accident according to equation 1:

$$\\ \begin{matrix}{P}_{DHR} \times ( {Tcs}^{{}_{} 4} - {TRRC}^{{}_{} 4} ) & [ Equation 1 ]\end{matrix}$$

In which T_{CS} denotes the temperature of the secondary vessel and T_{RRC} denotes the temperature of the RRC system.

Patent FR2987487B1 proposes a system which improves the heat transfer in the guard gap through forced circulation of the inerting gas. In spite of the advantages it affords, that disclosed system requires action on the part of the operator, as well as an electrical power supply.

Patent GB2263188A also proposes an RRC system that improves the transfer of heat by filling the guard gap with a metal, introduced in the solid state and which subsequently melts, thereby improving both the thermal inertia and the transfer of heat in the guard gap. This system according to patent GB2263188A improves the thermal performance of an RRC system because the thermal resistance of the guard gap is drastically reduced. However, this type of system has three major disadvantages:
the presence of a reservoir in which the solid material is stored when the reactor is operating normally. The volume of the reservoir is practically equivalent to that of the guard gap, and is located in proximity to the boiler, at the reactor closure. In the case of high-power reactors, the footprint of such a system may be significant, such a system may be complicated to configure, and safety studies need to take account of reservoir leakage events.
the system is irreversible. As a result, it is impossible to test it in a non-accident situation because it is extremely difficult to recover the solid or molten metal once it is in the guard gap;
in a post-accident dismantling situation, operations performed in the guard gap would be even more difficult because they would be hampered by the presence of a coating or residue of solid metal attached to the primary vessel and/or to the secondary vessel.

There is therefore still a need to improve DHR systems of RRC type of liquid metal reactors notably so as to passively increase the transfer of heat in an accident situation.

There is further still a need for a system which meets the abovementioned requirement and which is reversible so as to make it possible:
to keep the guard gap full of inerting gas during normal operation, thus improving the energy efficiency of the nuclear installation comprising a liquid metal reactor;
to guarantee correct operation by performing suitable periodic checks in order to test and guarantee the availability thereof when the reactor encounters an accident situation;
to return the reactor to normal operation in the event of untimely triggering of the system.

The aim of the invention is to at least partly meet these needs.

### SUMMARY OF THE INVENTION

In order to achieve this, the invention relates, in one of its aspects, to a nuclear reactor of the liquid metal or molten salt fast neutron reactor type, comprising:
a vessel referred to as primary vessel, filled with a liquid metal or with a molten salt by way of primary coolant for the reactor primary coolant circuit;
a vessel referred to as secondary vessel, arranged around the primary vessel and defining a guard vessel gap (E) between these;
a reactor pit, arranged around the secondary vessel;
a reactor closure to enclose the coolant inside the primary vessel;
a heat removal system for removing at least some of both the nominal heat and the decay heat of the reactor, the system comprising:
   a closed circuit filled with a coolant and configured so that the coolant circulates therein by natural or forced convection and remains in the liquid state both in nominal operation of the nuclear reactor and in reactor shutdown situations, the closed circuit comprising a serpentine coil arranged between the reactor pit and the secondary vessel, and wound in a helix around the latter;
   a module fixed to the reactor closure and comprising:
      at least a shell arranged inside the guard gap (E) and in contact with the secondary vessel,
      a plurality of heat-conducting fins arranged inside the guard gap (E) and angularly distributed around the primary vessel in columns, each column comprising several fins spaced away from one another over at least part of the height of the secondary vessel and mounted with the ability to pivot along the secondary vessel between a retracted position in which they are distant from the primary vessel and a deployed position in which they are in contact with the primary vessel,
      one or more Seebeck-effect thermoelectric element(s) arranged inside the shell and extending along the secondary vessel with their hot side in the lower part of the shell and their cold side in the upper part of the shell, the Seebeck-effect thermoelectric element(s) being designed so that during nominal operation of the nuclear reactor, the current that they generate leaves the fins in their retracted position, whereas in an accident situation in which decay heat needs to be removed, the current that they generate causes the fins to pivot into their deployed position.

What is meant here and in the context of the invention by “shutdown situations” is a normal reactor shutdown and a reactor shutdown in an accident situation (accident operation).

According to one advantageous embodiment, the module is suspended from the reactor closure. A setup whereby the module is suspended beneath the reactor closure is advantageous over some other setup, such as using welding, because it is easier to achieve. Dismantling is also easier.

According to an advantageous embodiment variant, the module comprises a plurality of pivots on each of which a fin is mounted with the ability to pivot, each pivot incorporating within it an electric motor, preferably a geared electric motor, which is electrically powered by the Seebeck-effect thermoelectric element(s). Such integration is compact and allows for reliable operation. As a preference, each pivot is fixed directly, and more preferably by welding, to the shell.

Advantageously, the fins lie vertically against the secondary vessel in their retracted position. This makes it possible to leave the guard gap as clear as possible so that, with fins of a small thickness, typically of the order of a cm, this leaves the maximum opportunity for inspection of said gap, notably using a robot, when the nuclear reactor is in normal operation.

The fins may be planar or of a curved shape with a curvature that defines a surface for contact with the primary vessel in their deployed position. In general, the shape of the fins is adapted to ensure an optimal area of contact between the fin tips and the primary vessel, and therefore optimal thermal conduction between the latter and the secondary vessel during the operation of removing decay heat from the nuclear reactor.

According to one advantageous feature, the p-type material of the Seebeck-effect thermoelectric element(s) is selected from lead telluride (PbTe), a mixture (TAGS) of antimony telluride (Sb₂Te₃), germanium telluride (GeTe) and silver telluride (Ag₂Te), or a skutterudite (CeFe₄Sb₁₂). Such materials are perfectly suited to generating current below a temperature threshold desired for the pivoting of the fins during normal operation of the reactor, and above this temperature threshold in an accident situation requiring decay heat removal. Typically, these materials are perfectly suitable for a difference in temperature between the bottom of the secondary vessel and the reactor closure of around 250° C. and 450° C. in normal operation and in an accident situation requiring decay heat removal.

According to one advantageous embodiment, the nuclear reactor comprises mechanical and/or electrical means for returning the fins from their deployed position to their retracted position.

According to this embodiment and a first variant, the electrical means may comprise an electrical power source known as a back-up source for generating an electrical current that is the opposite of that generated by the Seebeck-effect thermoelectric element(s).

According to this embodiment and a second variant, the mechanical means may comprise a mechanical device that is to be actuated manually, such as a winch.

With such mechanical and/or electrical means, the operation of the fins module of the DHR system is reversible and can be tested when desired during normal operation of the reactor.

According to an advantageous configuration, each column of fins extends substantially over the height of the cylindrical part of the secondary vessel. This then optimizes the potential area for conduction of heat between the primary and secondary vessels.

According to a complementary embodiment, the reactor comprises a system for filling the guard gap (E) that separates the non-cylindrical parts of the primary and secondary vessels with liquid metal, the system being able to be actuated in a nuclear reactor accident or on the decision of an operator following reactor shutdown. That means that there is no need to install the fins between notably hemispherical parts of the primary and secondary vessels where fitting such fins may prove complex.

As a preference, the fins and the shell are made of steel or of aluminium. As a further preference, the fins may be made of stainless steel such as steel AISI-316L, which offers good mechanical integrity and corrosion resistance.

In the case of the fins, aluminium alloys, for example aluminium 1060 may be used as a preference over steel because aluminium has a conductivity that is higher, up to 10 times higher depending on the alloy, than that of steel. In addition, aluminium is approximately three times lighter in weight than steel, which advantageously makes it easier to fit the fins in the guard gap. Moreover, aluminium and its alloys are resistant to corrosion and can be welded easily using standard methods.

The melting point, around 650° C. in the case of aluminium 1060, makes it possible to envisage using it to make fins for use in the event of an accident situation where the maximum reactor vessel temperature in the event of an accident is below 600-650° C.

In order to minimize the thermal resistance between the primary and secondary vessels during operation with decay heat removal (the fins in the deployed position), the coefficient of annular distribution of the fins in the guard gap, defined as the percentage of the level of occupancy of the cross section of this gap by the fins in their deployed position, being greater than 60% and preferably greater than 80%.

Thus, the DHR system with pivoting-fins module according to the invention accomplishes the function of decay heat removal (DHR) and ensures containment of the radioactivity while preserving the integrity of the primary radiation barrier (the fuel cladding) and of the secondary radiation barrier (the main vessel).

Thanks to the pivoting-fins module, the thermal resistance between the primary and secondary vessels is reduced in an accident situation whereby decay heat is removed by contact, which may be direct contact, of the fins with the primary vessel in the deployed position of these fins so that heat can therefore be transferred directly by conduction to the secondary vessel which in its turn transmits the heat to the serpentine coil of the DHR system wound around this vessel.

Furthermore, actuation of the fins may be triggered actively by an operator following a normal reactor shutdown.

The invention therefore essentially consists in creating a nuclear reactor incorporating a DHR system that simultaneously guarantees:
removal of decay heat as soon as the reactor is shut down;
removal of heat through the primary vessel and then behind the secondary vessel;
improved and entirely passive (Seebeck effect) heat removal by thermal conduction through fins distributed around the primary vessel in the guard gap and which, when pivoted into their deployed position, form a kind of thermal bridge between the primary and secondary vessels.

The DHR system according to the invention therefore differs from the systems according to the prior art in terms of the way in which the heat is removed passively, from outside the primary vessel, by using the high-temperature radiation therefrom towards the guard gap and the propagation of this heat both by radiation and thermal conduction into the secondary vessel by means of the fins in their deployed position.

The DHR system is in constant operation, both when the reactor is operating normally at nominal power, and when it is operating in an accident situation with the fins performing an active heat dissipating role.

The invention applies to all liquid sodium or other liquid metal or liquid salt reactors whatever their configuration, characterizing the primary coolant circuit mode, which are small or medium power reactors or SMRs (Small Modular Reactors), typically with an operating power of between 50 and 200 MWe, which are high-power reactors, namely:
pool-type SFRs for which the entirety of the primary coolant pumps and heat exchangers is contained within the main vessel containing the core and are immersed in the main vessel coolant through the reactor vessel closure.
hybrid (partial-pool-type) SFRs for which the primary pumps are contained inside the main vessel that contains the core;
loop-type SFRs for which the primary coolant pumps and the intermediate heat exchangers are placed in dedicated vessels outside the main reactor vessel which then contains only the core and the internals, the main vessel and the components vessel being connected by primary piping.

The primary coolant circuit coolant is preferably a liquid metal selected from a binary lead-bismuth (Pb—Bi) alloy, a binary sodium-potassium (NaK) alloy, sodium or other ternary alloys of liquid metals.

The favoured applications of the invention are small-sized reactors of the GenIV family, notably reactors cooled using sodium, lead or salt.

Further advantages and features of the invention will become more clearly apparent from reading the detailed description of implementation examples of the invention, which is given by way of non-limiting illustration with reference to the following figures.

### BRIEF DESCRIPTION OF THE DRAWINGS

FIG. 1 is a schematic view in partial section of a sodium fast reactor (SFR) with a DHR system of RRC type intended to implement the invention.

FIG. 2 is a view in longitudinal partial section showing the primary vessel and part of the fuel assemblies of an SFR nuclear reactor and part of the row of pipes of a DHR system according to the invention.

FIG. 3 is a schematic view of a pool-type SFR in longitudinal partial section, showing the primary and secondary vessels, the reactor core and part of a row of pipes of a DHR system around the secondary vessel of a pool-type SFR nuclear reactor according to the invention.

FIGS. 4A, 5A and 6A are views respectively from above, from the side, and from face-on, of a module of a column of fins of a DHR system according to the invention, the fins being in their retracted position lying vertically against the secondary vessel, which position corresponds to normal operation of the SFR nuclear reactor.

FIGS. 4B, 5B and 6B are views respectively from above, from the side, and from face-on, of a module of a column of fins of a DHR system according to the invention, the fins being in their deployed position in contact with the primary vessel, which position corresponds to accident-situation operation of the SFR nuclear reactor.

FIGS. 7A and 7B illustrate the figure of merit, denoted z, of different p-type thermoelectric materials which are suitable in the context of the invention, and the range of relevant temperatures respectively when the SFR nuclear reactor is in normal operation and operating in an accident situation.

FIG. 8 illustrates, in the form of a curve, how the ratio of the thermal resistance between the primary and secondary vessels changes as a function of the coefficient of annular distribution of the fins according to the invention, with the fins having a thickness equal to 1 cm.

FIG. 9 is an enlargement of FIG. 8.

FIG. 10 illustrates, in the form of a curve, how the ratio of the thermal resistance between the primary and secondary vessels changes as a function of the increase in the thickness of the fins according to the invention.

FIG. 11 illustrates, in the form of a curve, how the ratio of the thermal resistance between the primary and secondary vessels changes as a function of the coefficient of annular distribution of the fins according to the invention, with the fins having a thickness equal to 10 cm.

FIG. 12 is a side view of a fins module of a DHR system according to a variant of the invention, the fins, which have a curved contact surface, being in their deployed position in contact with the primary vessel, which position corresponds to accident-situation operation of the SFR nuclear reactor.

### DETAILED DESCRIPTION

Throughout the present application, the terms “vertical”, “lower”, “upper”, “bottom”, “top”, “below”, “above” are to be understood with reference to a primary vessel filled with liquid sodium of a pool-type SFR, in its vertical operational configuration.

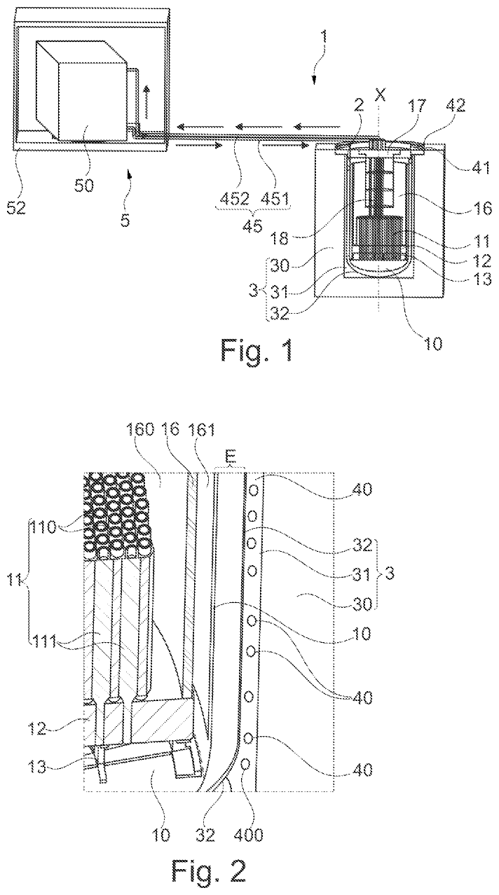

FIGS. 1 to 3 depict a sodium fast reactor (SFR) 1 with a pool-type architecture, having a reactor decay heat recovery (DHR) system 2 that is also in accordance with the invention.

Such a reactor 1 comprises a primary vessel 10 or reactor vessel, filled with liquid sodium, referred to as primary coolant, and which houses the core 11 in which are immersed a plurality of fuel assemblies 110 which generate thermal energy through nuclear fission of the fuel, and lateral neutron shielding assemblies (PNL) 111.

The primary vessel 10 supports the weight of the sodium of the primary coolant circuit and of the internals.

The core 11 is supported by two distinct structures making it possible to separate the functions of supporting the core and supplying the core with coolant:
an all-welded first pressure structure called a diagrid 12, in which the feet of the fuel assemblies 110 are positioned and which is supplied with cold sodium (400° C.) by primary coolant pumps 100;
an all-welded second structure called a strongback 13, on which the diagrid rests, the strongback generally resting on part of the internal wall in the bottom part of the primary vessel 10.

Typically, the diagrid 12 and the strongback 13 are made of stainless steel AISI 316L.

The claddings of the fuel assemblies 110 constitute the first containment barrier while the vessel 10 constitutes the second containment barrier.

As depicted, the primary vessel 10 is of cylindrical shape with central axis X extended by a hemispherical bottom. Typically, the primary vessel 10 is made of stainless steel AISI 316L with a very low boron content in order to guard against the risk of cracking at high temperature. Its external surface is rendered highly emissive by a pre-oxidation treatment which is carried out in order to facilitate the radiation of heat to the outside during the decay heat removal phase.

A plug 18 known as a core head plug is fitted vertically above the core 11.

In such a reactor 1, the heat produced during the nuclear reactions within the core 11 is removed by circulating the primary sodium, using pumping means 100 sited in the reactor vessel 10, to intermediate heat exchangers 15 sited inside the primary vessel 10 in the example illustrated.

Thus, during conditions of normal operation of the reactor, the extraction of heat is performed by the secondary sodium arriving cold via its conveying pipe 152, at an intermediate heat exchanger 15 before re-emerging hot therefrom via its outlet pipe 151.

The heat extracted is then used to produce steam in steam generators which have not been depicted, the steam produced being conveyed to one or more turbines and alternators which have likewise not been depicted. The turbine(s) convert the mechanical energy of the steam into electrical energy.

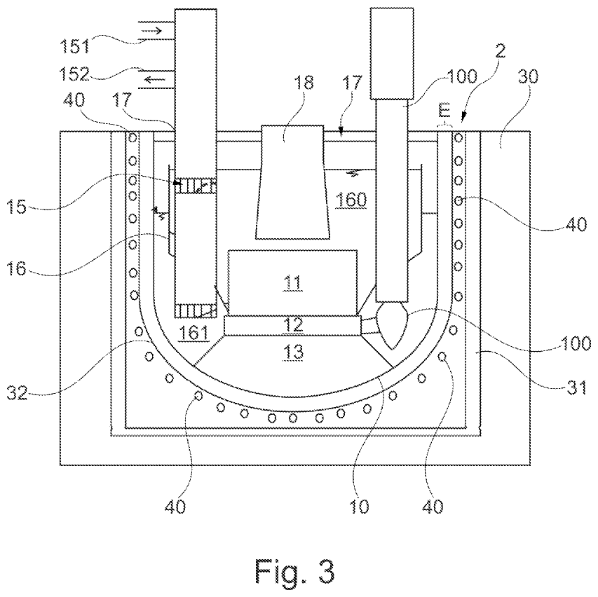

The reactor vessel 10 is divided into two distinct zones by a separation device consisting of at least one vessel 16 arranged inside the reactor vessel 10. This separation device is also known as a redan and is made of stainless steel AISI 316L. In general, as illustrated in FIG. 3, the separation device consists of a single interior vessel 16 the shape of which is cylindrical at least in its top part.

The redan 16 is generally welded to the diagrid 12 as shown in FIG. 3.

As illustrated in FIG. 3, the primary sodium zone internally delimited by the internal vessel 16 collects the sodium leaving the core 11: it constitutes the zone in which the sodium is at its hottest and is therefore commonly referred to as the hot zone 160 or hot header. The primary sodium zone 161 delimited by the internal vessel 16 and the reactor vessel 10 collects the primary sodium and supplies it to the pumping means: it constitutes the zone in which the sodium is at its coldest and is therefore commonly referred to as the cold zone or cold header 161.

As illustrated in FIG. 3, the reactor vessel 10 is anchored or set down in the upper part and closed by a reactor closure 17 that supports the various components, such as the pumping means, which have not been depicted, certain components of the removal system 2, as specified hereinafter, and the core head plug 18. The reactor closure 17 is therefore an upper cover which encloses the liquid sodium inside the primary vessel 10. Typically, the closure 17 may be made of an unalloyed steel (A42). This sealed closure allows the vessel overhead to be inerted.

The sealing of the primary vessel 10 is guaranteed by a metal gasket between the reactor closure 17 and the core head plug 18.

The core head plug 18 is a rotary plug which carries all of the handling systems and all of the instrumentation necessary for monitoring the core and including the control rods, the number of which is dependent on the type of core and the power thereof, as well as the thermocouples and other monitoring devices. Typically, the core head plug 18 is made of stainless steel AISI 316L.

The space between the reactor closure 17 and the free surfaces of the sodium, often known as the reactor-pile overhead, is filled with a cover of gas that is neutral with respect to sodium, typically argon.

A support and containment system 3 is arranged around the primary vessel 10 and under the reactor closure 17.

More specifically, as shown in FIGS. 2 and 3, this system 3 comprises a reactor pit 30, into which there are inserted, from the outside towards the inside, a layer of thermally insulating material 31, a secondary vessel (guard vessel) 32 and the primary reactor vessel 10.

The reactor pit 30 is a block of parallelepipedal overall external shape which supports the weight of the reactor closure 17 and therefore of the components that this itself supports. The reactor pit 30 has the functions of providing biological protection and protection against external attack, and also of providing cooling of the external environment in order to maintain low temperatures. Typically, the reactor pit 30 is a block of concrete.

The layer of thermally insulating material 31 provides thermal insulation of the reactor pit 30. Typically, the layer 31 is made of a polyurethane or silicate-based foam.

The secondary vessel 32 provides containment for the primary sodium in the event of a leak from the primary vessel 10 and protects the reactor pit 30. The secondary vessel 32 bears against the reactor pit 30 and its top part is welded to the reactor closure 17. Typically, the secondary vessel 32 may be made of stainless steel AISI 316L.

The space E between the secondary vessel 32 and the primary vessel 10, known as the guard gap, is filled with a thermally conducting gas such as nitrogen. This gap must be large enough to accommodate the inspection systems used. Typically, the width of the guard gap E is around 20 cm.

The DHR system 2 according to the invention for removing residual heat through the primary vessel 10 is now described with more particular reference to FIGS. 2 and 3.

The DHR system 2 according to the invention will allow the decay heat to be removed to outside the primary vessel 10 entirely passively by capturing the high-temperature radiation in the guard gap E.

The system 2 first of all comprises a closed-circuit 4 filled with a liquid metal and which comprises:
a serpentine coil 40, arranged in a helix in the guard gap E around the primary vessel 10,
a first cold header 41, welded directly to one of the ends of the serpentine coil 40, the cold header being sited outside and on top of the reactor closure 17,
a first hot header 42, welded directly to the other of the ends of the serpentine coil 40, the hot header being sited outside and on top of the reactor closure 17, and preferably vertically above the first cold header 41.

The headers 41 and 42 are connected to the cold source of the system 50 by the piping 451 and 452.

The reactor closure 17 on its upper part supports the weight of the components that support the cold header 41 and hot header 42.

The reactor closure 17 has openings of different types to allow the insertion of the serpentine coil 40, which enters and exits via the top of the closure 17.

The serpentine coil 40 has a diameter which is dependent on the diameter of the primary vessel 10 and a height that is great enough to have the surface area necessary for the requisite heat removal.

In other words, the total number of turns, the separation and the diameter of these turns that make up the serpentine coil 40 are dependent on the diameter of the primary vessel 10 and on the power of the nuclear reactor core 11. For example, the pitch of the turns of the serpentine coil 40 may be equal to 10 cm, which is a good compromise between manufacture and radiative heat absorption.

Again for example, the outside diameter of the serpentine coil 40 is fixed at a standard dimension of 5 cm, so as to minimize pressure drops, reduce the amount of space occupied by the pipes in the guard gap E and maximize the area exposed to the primary vessel 10. The thickness of the serpentine coil 40 is dependent on the mechanical stresses applied by the internal liquid metal and by its weight.

The material of the serpentine coil 40 needs to exhibit good emissivity properties. Typically, the material of the serpentine coil is chosen from stainless steel AISI 316L, ferritic steels, nickel, Inconel and Hastelloy. This material is dependent on the internal fluid used in the closed circuit 4.

This internal coolant C is a chemically stable, low viscosity liquid metal that is a good conductor and carrier of heat, chemically compatible with all of the pipework of the circuit 4 and able to operate in natural or forced convection in a temperature interval of between 150-600° C. Typically, the liquid metal of the circuit 4 may be chosen from an NaK alloy, a Pb—Bi alloy, sodium or one of the ternary alloys of the liquid metals, etc.

As shown in FIG. 1, the cold header 41 and the hot header 42 have a toroidal overall shape centred on the central axis (X) of the primary vessel 10. These headers 41, 42 rest against support pieces which are directly welded to the reactor closure 17.

As illustrated in FIG. 1, the DHR system 2 according to the invention also comprises a cold source 5 configured to absorb the heat removed by radiation from the primary vessel 10 through the entirety of the serpentine coil 40. The sizing of the cold source 5 is dependent both on the power of the reactor core 11, which in fact determines the amount of decay heat that is to be removed, and on the envisaged duration of the transient situation that is to be borne, which therefore entails substantially proportional thermal inertia.

The cold source 5 comprises at least a reservoir 50, sited some distance from the primary vessel 10 and elevated in relation to the reactor closure 17. As a preference, the reservoir 50 is contained within a containment building 52.

In order to situate the cold source 5 at the optimal distance from the primary vessel 10, the hydraulic circuit 2 comprises a connecting loop 45 comprising piping and, where applicable, valves, between the cold header 41 and hot header 42 and heat exchangers of the cold source 5.

More specifically, as illustrated in FIG. 1, the connecting loop 45 comprises a hydraulic leg 451 which connects the first cold header 41 to the cold end of a heat exchanger of the cold source 5 and a hydraulic leg 452 which connects the first hot header 42 to the hot end of the heat exchanger of the cold source 5.

Thus, the first cold header 41 distributes the flow of internal liquid metal from the cold leg 451 to each cold leg 401 of the serpentine coil 40, and the first hot header 42 collects the internal liquid metal coming from each hot leg 401 of the serpentine coil 40 to convey it to the hot leg 452.

The cold leg 451 and hot leg 452 are preferably sized so that they are as short as possible so as to reduce pressure drops and increase the flow rate of natural convection in the closed hydraulic circuit 4 in instances in which the flow is intended to be passive through the design of the DHR system.

Thus, the closed hydraulic circuit 4 which has just been described is configured so that the liquid metal coolant remains in the liquid state both during nominal operation of the nuclear reactor and in operation when the nuclear reactor is shut down and releasing decay heat.

According to the invention, the DHR system 2 of RRC type which has just been described comprises a module 6 of passively triggered thermally conducting fins 60 which are arranged in the cylindrical part of the guard gap E between the primary vessel 10 and the secondary vessel 32.

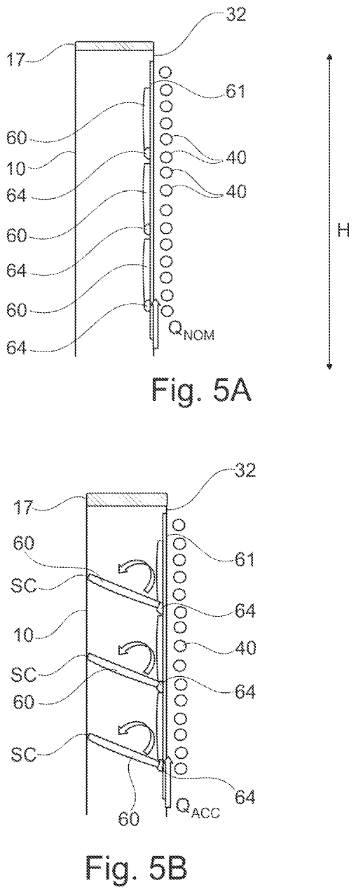

Advantageously, the module 6 is suspended from the reactor closure 17 by a shell 61, typically made of steel, which conforms to the shape of the secondary vessel 32, as illustrated in FIGS. 5A, 5B.

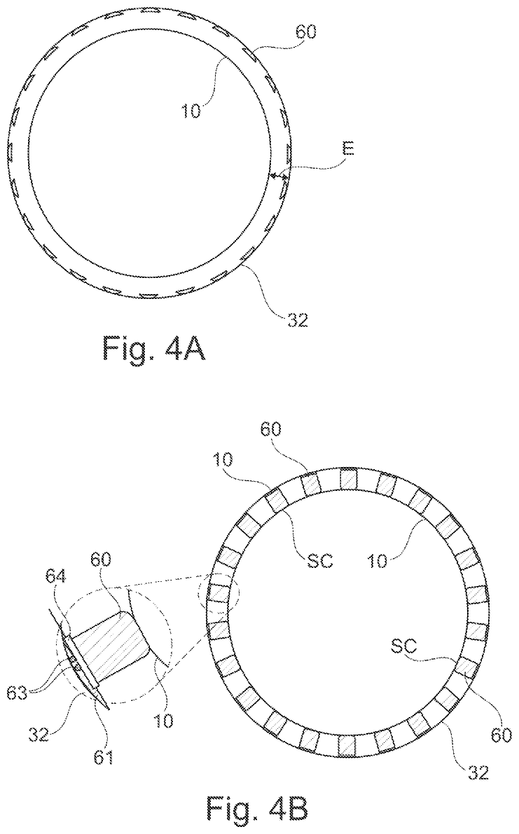

As visible in FIGS. 4A and 4B, the fins 60 of the module 6, which are typically made of steel or of aluminium, are grouped in columns 62 arranged inside the guard gap (E) and distributed, preferably evenly, around the primary vessel 10. By way of example, each fin 60 is a right parallelepiped with dimensions (thickness, width, length) equal to 1*5*25 cm.

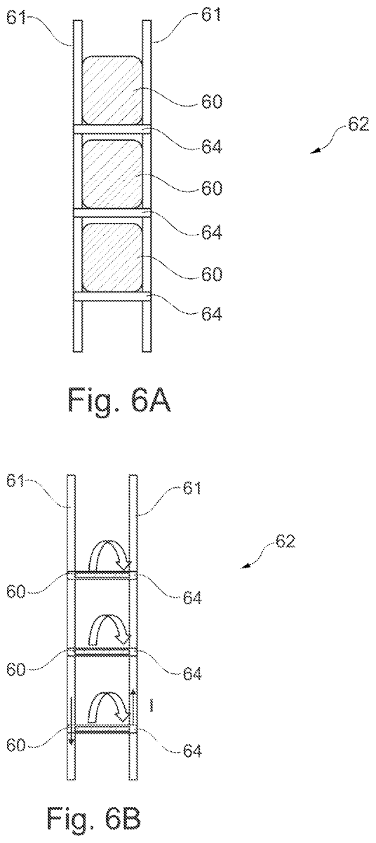

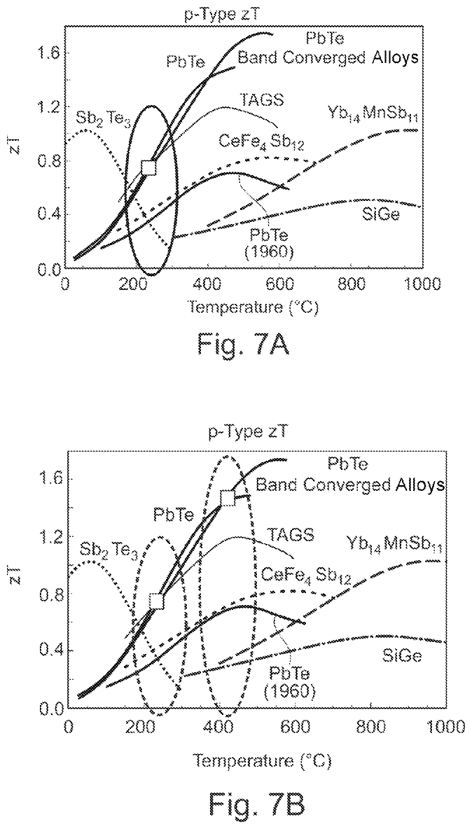

In each column 62, the fins 60 are spaced away from one another over the height H of the cylindrical part of the secondary vessel 32 and are mounted with the ability to pivot about pivots 64 along the secondary vessel between a retracted position in which they lie vertically against the secondary vessel 32 (FIGS. 4A, 5A, 6A) and a deployed position in which they are each in contact with the primary vessel 10 along a contact surface SC (FIGS. 4B, 5B, 6B).

The pivots 64 are welded to the steel shell which is in contact with the secondary vessel.

As shown in detail in FIG. 4B, Seebeck-effect thermoelectric elements 63 are arranged inside the shell 61 and extend along the secondary vessel 32 with their hot side in the bottom part of the shell 61 and their cold side in the top part of the shell 61. For information about the thermoelectric elements, reference may be made to [3]. Publication [4] mentions PbTe as a thermoelectric material that can be welded, and therefore have potentially elongate dimensions.

When the nuclear reactor is in operation, these Seebeck-effect thermoelectric elements 63 constantly generate electrical current because of the difference in temperature between the reactor closure 17 at which their cold side is situated and the bottom of the secondary vessel 32 at which their hot side is situated. This current I generated within the thermoelectric elements 63 is also transmitted to the pivots 64 which are electrically conducting.

Each of the pivots 64 houses an electric motor, preferably a geared motor, powered directly by the electric current. Thus, when the current generated by the thermoelectric elements 63 exceeds a threshold value, the pivots 64 are made to pivot from their vertical retracted position into their deployed position of contact with the primary vessel 10.

In normal operation of the reactor, the difference in temperature ΔT between the bottom of the secondary vessel 32 and the reactor closure 17, symbolized by the thermal flux Q_{NOM} in FIG. 5A, results in a current generated by the thermoelectric elements 63 which is below the threshold value beyond which the pivoting of the fins 60 is triggered. Under these conditions, the fins 60 remain in their vertical retracted position (FIGS. 4A, 5A, 6A). Given the small thickness that the fins 60 are able to have, it is still possible to make an inspection, notably using a robot, of the guard gap E during this normal operation of the reactor.

When the nuclear reactor is in a shutdown situation, the pivoting of the fins 60 is entirely passive and dependent only on the increase in temperature. Thus, in this operating scenario, the difference in temperature ΔT between the bottom of the secondary vessel 32 and the reactor closure 17, symbolized by the thermal flux Q_{ACC} in FIG. 5B, results in a current generated by the thermoelectric elements 63 which is above the threshold value beyond which the pivoting of the fins 60 is triggered.

The pivoting of the fins 60 by the rotation of their pivot 64 is assisted by the force of gravity which contributes to causing the fins 60 to drop down until they achieve physical contact SC with the primary vessel 10 (FIGS. 4B, 5B, 6B). As a result of this, transfer of heat by thermal conduction between the primary vessel 10 and the secondary vessel 32 is accelerated and the thermal flux is greater than with a DHR system that does not comprise fins. The points of contact SC that are generated encourage an increase in the temperature of the secondary vessel 32 and promote an increase in the amount of thermal power transferred by radiation to the DHR system 2.

The shape of the fins 60 is preferably tailored to generate maximum area of contact and therefore maximum conduction of heat between the primary vessel 10 and secondary vessel 32. At the same time, care is taken to ensure that this tailored shape does not generate mechanical load on the external surface of the primary vessel 10, so as to maintain the integrity of the latter under all circumstances. Of course, the radial thermal expansions of the primary vessel 10 and secondary vessel 32 are advantageously taken into consideration in determining the shape of the fins 60.

In order for the operation of the module 6 of fins 60 to be reversible, mechanical and/or electrical means for returning the fins 60 from their deployed position to their retracted vertical position are provided. The reversible nature of the module 6 means that it can be tested during normal operation of the nuclear reactor. By way of electrical means, a back-up power source, such as a battery, able to generate an electrical current that is the opposite of that generated by the Seebeck-effect thermoelectric element(s) 63, may be provided. By way of mechanical means, manually operated members, such as a mechanism of the winch type that can be actuated by hand, may be provided In order to improve the thermal conduction when operating in an accident situation, provision may be made for the non-cylindrical bottom part of the guard gap E to be filled with liquid metal at the moment of pivoting of the fins 60.

For application to reactor of SFR type, which is cooled by liquid sodium, thermoelectric elements of the lead telluride type may be perfectly suitable for the required operation and the temperature level below 650° C., and as is evident from the curves for p-type thermoelectric materials for a ΔT respectively of the order of 250° C. and of 450° C.

The inventors have used known heat mapping software such as the COPERNIC software to perform: preliminary calculations [5], [6] so as to study the influence that the following various parameters have on the ratio of thermal resistances in the guard gap E:
the coefficient of annular distribution of the fins, which may be defined as being the percentage of the surface area or level of occupancy of the cross section of the guard gap by the fins in their deployed position;
the thickness of a fin.

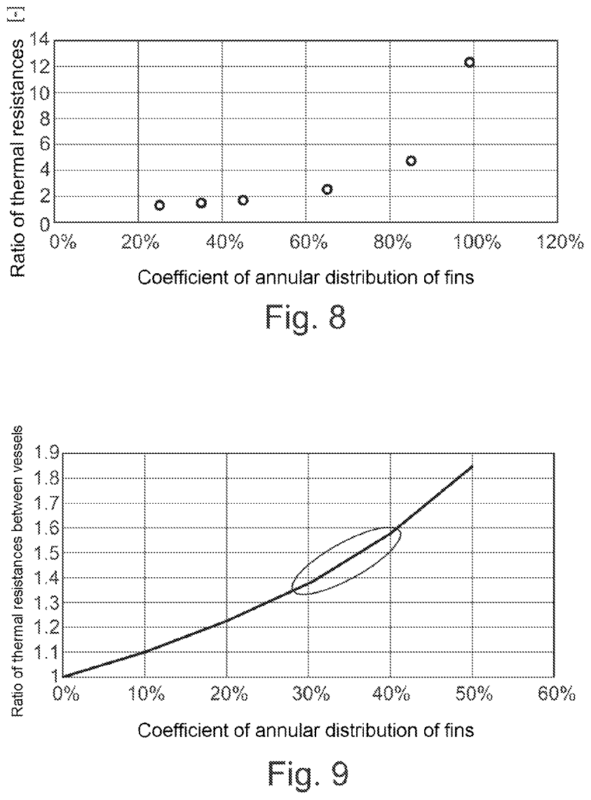

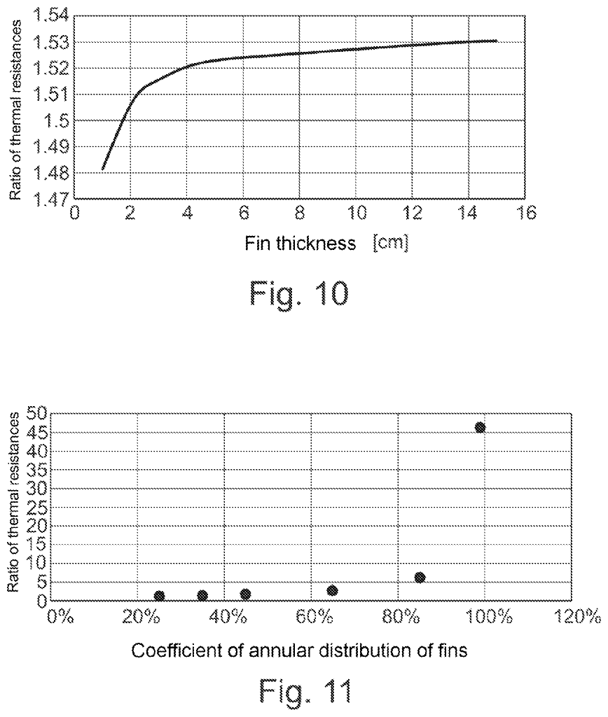

Results of these calculations are illustrated in the form of curves in FIGS. 8 to 11. It should be emphasized that in FIGS. 8 and 9, the thickness of the fins 60 is around 1 cm whereas in FIG. 11 it is 10 cm.

From these curves it may be seen that the thickness of the fin 60 is not a parameter that contributes to a significant reduction of the thermal resistance of the guard gap E, provided that the level of occupancy of this gap by the fins 60 is low.

By contrast, a more dense annular distribution of the fins 60 may encourage a reduction in the thermal resistance of the guard gap E by as much as a factor of 10 or more in comparison with a fin-free configuration.

As the enlargement of FIG. 9 shows, it may for example be seen that there is a 50% reduction in the overall thermal resistance of the guard gap E if the fin annular distribution factor is comprised between 30% and 40%. When this factor is upwards of 60%, the reduction is even greater.

This means to say that if the thermal flux is applied to the wall of the primary vessel 10, the difference in temperature between this vessel and the secondary vessel 32 becomes 10 times lower with the favourable consequence of greatly increasing the heat removed by the DHR system 2 when the reactor is in a shutdown situation.

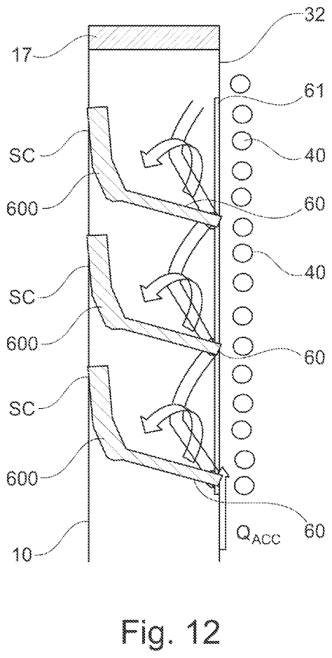

This heat removal can be increased still further by increasing the area of contact (SC) between the primary vessel 10 and the secondary vessel 32. One possibility is shown in FIG. 12 with fins 60 that have a curved shape 600 which ensures a more extensive area of contact SC when they pivot.

It must be emphasized here that the results from the above studies are preliminary and need to be confirmed by 2-D or 3-D heat conduction calculations.

The invention is not limited to the examples that have just been described; features of the illustrated examples may in particular be combined together within variants that have not been illustrated.

Further variants and embodiments may be envisioned without however departing from the scope of the invention.

While in all of the illustrated examples, the DHR system 2 with its module 6 of passively triggered fins has been described in relation to a pool-type nuclear reactor, it is entirely possible to implement it in a loop-type nuclear reactor with intermediate heat exchangers sited outside of the primary vessel.

While in all of the examples illustrated, the pivoting of the fins 60 is exclusively passive resulting from the threshold current flowing through the Seebeck-effect thermoelectric elements 63, it is possible to envision an actively triggered configuration, notably for instances of operation in a situation of reactor shutdown (accidental or scheduled), resulting from injection of a current not originating from the thermoelectric elements 63.

Other, more optimal and better-performing pairs of materials may be selected according to the design and concept of the reactor (the temperature levels encountered in normal and accidental operating situations may vary depending on the configuration).

In place of a reservoir 50 it is possible to envision other means by way of cold source.

By way of example, the cold source may be a pool of water if the fluid inside the circuit is a heat transfer oil, which may or may not be contained within a containment building. It may also be an exhaust stack with an NaK/air exchanger if the internal fluid inside the circuit is NaK.

### LIST OF CITED REFERENCES

[1]: https://www.nrc.gov/docs/ML1914/ML19149A378.pdf
[2]: B. S. TRIPLETT et al., «PRISM: A competitive small modular sodium-cooled reactor,» Nuclear Technology, vol. 178, pp. 186-200, 2012.
[3]: Thermoelectrics—Northwest Materials Science and Engineering: http://thermoelectrics.matsci.northwestern.edu/thermoelectrics/index.html.
[4]: X. REALES FERRERES “Fabrication and Characterisation of High Temperature PbTe-based Thermoelectric Modules for Waste Heat Recovery Applications, Thermoelectric Modules for Waste Heat Recovery Applications”. University of Wollongong Thesis Collection 2017+. https://ro.uow.edu.au/cgi/viewcontent.cgi?article=1325&context=theses1
[5]: F. MORIN et al., “COPERNIC, A NEW TOOL BASED ON SIMPLIFIED CALCULATION METHODS FOR INNOVATIVE LWRs CONCEPTUAL DESIGN STUDIES”, ICAPP 2017 Conference, 2017.
[6]: P. GAUTIHE et al., “Innovative and inherently safe small SFR as a response to the dilemma ‘safety vs cost’”, ICAPP 2019 Conference, 2019.

1. A nuclear reactor of the liquid metal or molten salt fast neutron reactor type, comprising:
a vessel referred to as primary, vessel, filled with a liquid metal or with a molten salt by way of primary coolant for the reactor primary coolant circuit;
a vessel referred to as secondary vessel, arranged around the primary vessel defining a guard vessel gap (E) between the primary vessel and the secondary vessel;
a reactor pit, arranged around the secondary vessel;
a reactor closure to enclose the coolant inside the primary vessel;
a heat removal system for removing at least some of both the nominal heat and the decay heat of the reactor, the system comprising:
a closed circuit filled with a coolant and configured so that the coolant circulates therein by natural or forced convection and remains in the liquid state both in nominal operation of the nuclear reactor and in reactor shutdown situations, the closed circuit comprising a serpentine coil arranged between the reactor pit and the secondary vessel, and wound in a helix around the latter;
a module fixed to the reactor closure and comprising:
at least a shell arranged inside the guard gap (E) and in contact with the secondary vessel,
a plurality of heat-conducting fins arranged inside the guard gap (E) and angularly distributed around the primary vessel in columns, each column comprising several fins spaced away from one another over at least part of the height of the secondary vessel and mounted with the ability to pivot along the secondary vessel between a retracted position in which they are distant from the primary vessel and a deployed position in which they are in contact with the primary vessel,
one or more Seebeck-effect thermoelectric element(s) arranged inside the shell and extending along the secondary vessel with their hot side in the lower part of the shell and their cold side in the upper part of the shell, the Seebeck-effect thermoelectric element(s) being designed so that during nominal operation of the nuclear reactor, the current that they generate leaves the fins in their retracted position, whereas in an accident situation in which decay heat needs to be removed, the current that they generate causes the fins to pivot into their deployed position.

2. The nuclear reactor according to claim 1, the module being suspended from the reactor closure.

3. The nuclear reactor according to claim 1, the module comprising a plurality of pivots on each of which a fin is mounted with the ability to pivot, each pivot incorporating within it an electric motor, which is electrically powered by the Seebeck-effect thermoelectric element(s).

4. The nuclear reactor according to claim 3, each pivot being fixed directly to the shell.

5. The nuclear reactor according to claim 1, the fins lying vertically against the secondary vessel in their retracted position.

6. The nuclear reactor according to claim 1, the fins being planar or of a curved shape with a curvature that defines a surface for contact with the primary vessel in their deployed position.

7. The nuclear reactor according to claim 1, the p-type material of the Seebeck-effect thermoelectric element(s) being selected from lead telluride (PbTe), a mixture (TAGS) of antimony telluride Sb2Te3), germanium telluride (GeTe) and silver telluride (Ag2Te), or a skutterudite (CeFe4Sb12).

8. The nuclear reactor according to claim 1, comprising a return device for returning the fins from their deployed position to their retracted position.

9. The nuclear reactor according to claim 8, the return device comprising an electrical power source known as a back-up source for generating an electrical current that is the opposite of that generated by the Seebeck-effect thermoelectric element(s).

10. The nuclear reactor according to claim 9, the return device comprising a mechanical device that is to be actuated manually, such as a winch.

11. The nuclear reactor according to claim 1, each column of fins extending substantially over the height of the cylindrical part of the secondary vessel.

12. The nuclear reactor according to claim 1, comprising a system for filling the guard gap (E) that separates the non-cylindrical parts of the primary and secondary vessels with liquid metal, the system being able to be actuated in a nuclear reactor accident or on the decision of an operator following reactor shutdown.

13. The nuclear reactor 4 according to claim 1, the fins and the shell being made of steel or of aluminium.

14. The nuclear reactor according to claim 1, the coefficient of annular distribution of the fins in the guard gap, defined as the percentage of the level of occupancy of the cross section of said gap by the fins in their deployed position, being greater than 60%.

15. The nuclear reactor according to claim 1, of the loop type or of the pool type.
